(19) United States
(12) Patent Application Publication
(10) Pub. No.: US 2019/0088218 A1
(43) Pub. Date: Mar. 21, 2019

(54) Pixel Structure and Corresponding Liquid Crystal Display Panel

(71) Applicant: Shenzhen China Star Optoelectronics Technology Co., LTD., Shenzhen (CN)

(72) Inventors: Yuyeh Chen, Shenzhen (CN); Jhenwei He, Shenzhen (CN); Hao Xing, Shenzhen (CN)

(21) Appl. No.: 15/312,626

(22) PCT Filed: Jul. 12, 2016
(86) PCT No.: PCT/CN2016/089713

§ 371 Date: Nov. 18, 2016

(30) Foreign Application Priority Data
Jun. 7, 2016 (CN) 201610396995.7

(51) Int. Cl. G09G 3/36; G02F 1/133

(52) U.S. Cl. CPC G09G 3/3614; G09G 3/3607; G09G 3/3674; G09G 2300/0426; G02F 1/13306; G09G 2300/0452; G09G 3/3685

(57) ABSTRACT

A pixel structure is described and has data lines, scan lines and pixel units disposed between the data lines and the scan lines. An Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)st data line, wherein N is a non-negative integer, and M is a positive integer. A liquid crystal display panel is further described.

### FIELD OF THE INVENTION

The present invention relates to a liquid crystal display technical field, and more particularly to a pixel structure and a corresponding liquid crystal display panel.

### BACKGROUND OF THE INVENTION

With the development of liquid crystal display technology, a relatively high screen sense has become one of main targets of display product competitiveness of major panel makers, wherein a main factor affecting the screen sense of a liquid crystal display panel is a crosstalk appearing in the screen, a flicker appearing in the screen, and so on.

A pixel structure of a liquid crystal display panel can be better to solve the screen's crosstalk and the screen's flicker, as shown in FIG. 1A and FIG. 1B. FIG. 1A is a pixel polarity of each of pixel units of an odd frame screen of a conventional pixel structure. FIG. 1B is a pixel polarity of each of pixel units of an even frame screen of a conventional pixel structure. As shown in the figures, the pixel structure uses a method of two-line inversion, i.e., pixel polarities of the pixel units of the two neighboring rows are identical to each other, and pixel polarities of the pixel units of the two neighboring columns are identical to each other. This kind of structure can better prevent the problems of the screen's crosstalk and the screen's flicker.

However, when the above pixel structure is used to display a screen, after scanning every two rows of the pixel units, all of the driving currents corresponding to data lines immediately need to perform a polarity inversion to data line signals. This results in a greater power consumption of the driving currents of the liquid crystal display panel; and this may cause a relatively high temperature of a driving chip in the driving currents to affect a display stability of the liquid crystal display panel.

As a result, it is necessary to provide a pixel structure and a corresponding liquid crystal display panel to solve the problems existing in the conventional technologies.

### SUMMARY OF THE INVENTION

An embodiment of the present invention provides a pixel structure and a corresponding liquid crystal display panel having a relatively small power consumption and a better display stability, for solving the technical problems of a greater power consumption and a relatively poor display stability of the conventional pixel structure and the corresponding liquid crystal display panel.

An embodiment of the present invention provides a pixel structure, comprising a plurality of data lines, a plurality of scan lines and a plurality of pixel units disposed between the data lines and the scan lines,
wherein an Mth pixel unit of an (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)st data line;
wherein a pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row;
wherein a pixel polarity of an Mth pixel unit of a (4N+1)th column is identical to that of an Mth pixel unit of a (4N+2)nd column; a pixel polarity of the Mth pixel unit of the (4N+2)nd column is opposite that of an Mth pixel unit of a (4N+3)rd column; and a pixel polarity of the Mth pixel unit of the (4N+3)th column is identical to that of an Mth pixel unit of a (4N+4)th column;
wherein N is a non-negative integer, and M is a positive integer.

In the pixel structure described by the present invention, an inversion is performed to a polarity of a data signal of an odd column data line of a neighboring frame; and a two-line inversion is performed to a polarity of a data signal of an even column data line in the same frame screen.

In the pixel structure described by the present invention, the pixel unit of an Ath row is connected to the Ath scan line, wherein A is a positive integer.

In the pixel structure described by the present invention, the pixel structure comprises red pixel units, green pixel units, and blue pixel units.

In the pixel structure described by the present invention, the pixel structure comprises red pixel units, green pixel units, blue pixel units, and white pixel units.

In the pixel structure described by the present invention, the pixel polarity of the Mth pixel unit of the (4N+1)st row is identical to that of an Mth pixel unit of a (4N+5)th row.

In the pixel structure described by the present invention, the pixel polarity of the Mth pixel unit of the (4N+1)st column is identical to that of an Mth pixel unit of a (4N+5)th column.

An embodiment of the present invention further provides a pixel structure, comprising a plurality of data lines, a plurality of scan lines and a plurality of pixel units disposed between the data lines and the scan lines,
wherein an Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)th data line;
wherein a pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row;
wherein a pixel polarity of an Mth pixel unit of a (4N+1)st column is opposite that of an Mth pixel unit of a (4N+2)nd column; a pixel polarity of the Mth pixel unit of the (4N+2)nd column is identical to that of an Mth pixel unit of a (4N+3)rd column; and a pixel polarity of the Mth pixel unit of the (4N+3)rd column is opposite that of an Mth pixel unit of a (4N+4)th column;
wherein N is a non-negative integer, and M is a positive integer.

In the pixel structure described by the present invention, an inversion is performed to a polarity of a data signal of an even column data line of a neighboring frame; and a two-line inversion is performed to a polarity of a data signal of an odd column data line in the same frame screen.

In the pixel structure described by the present invention, the pixel unit of an Ath row is connected to the Ath scan line, wherein A is a positive integer.

In the pixel structure described by the present invention, the pixel structure comprises red pixel units, green pixel units, and blue pixel units.

In the pixel structure described by the present invention, the pixel structure comprises red pixel units, green pixel units, blue pixel units, and white pixel units.

In the pixel structure described by the present invention, the pixel polarity of the Mth pixel unit of the (4N+1)st row is identical to that of an Mth pixel unit of a (4N+5)th row.

In the pixel structure described by the present invention, the pixel polarity of the Mth pixel unit of the (4N+1)st column is identical to that of an Mth pixel unit of a (4N+5)th column.

An embodiment of the present invention further provides a liquid crystal display panel, comprising a pixel structure and a driving current configured to drive the pixel structure, wherein the pixel structure comprises a plurality of data lines, a plurality of scan lines and a plurality of pixel units disposed between the data lines and the scan lines,
wherein an Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)th data line;
wherein a pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row;
wherein a pixel polarity of an Mth pixel unit of a (4N+1)st column is identical to that of an Mth pixel unit of a (4N+2)nd column; a pixel polarity of the Mth pixel unit of the (4N+2)th column is opposite that of an Mth pixel unit of a (4N+3)rd column; and a pixel polarity of the Mth pixel unit of the (4N+3)th column is identical to that of an Mth pixel unit of a (4N+4)th column;
wherein N is a non-negative integer, and M is a positive integer.

In the liquid crystal display panel described by the present invention, an inversion is performed to a polarity of a data signal of an odd column data line of a neighboring frame; and a two-line inversion is performed to a polarity of a data signal of an even column data line in the same frame screen.

In the liquid crystal display panel described by the present invention, the pixel unit of an Ath row is connected to the Ath scan line, wherein A is a positive integer.

In the liquid crystal display panel described by the present invention, the pixel structure comprises red pixel units, green pixel units, and blue pixel units.

In the liquid crystal display panel described by the present invention, the pixel structure comprises red pixel units, green pixel units, blue pixel units, and white pixel units.

Compared with the conventional pixel structure and the corresponding liquid crystal display panel, the pixel structure and the corresponding liquid crystal display panel of the present invention can decrease an inverting frequency of the polarity of the data signal in every screen, thereby decreasing the power consumption of the corresponding liquid crystal display panel and improving the display stability of the corresponding liquid crystal display panel. The technical problems of the greater power consumption and the relatively poor display stability of the conventional pixel structure and the corresponding liquid crystal display panel are solved.

### DESCRIPTION OF THE DRAWINGS

In order to more clearly describe embodiments of the present invention or technical solutions in the prior art, drawings required to be used for the embodiments are simply described hereinafter. The drawings described below only illustrate some embodiments of the present invention. Those skilled in the art can obtain other drawings based on these drawings disclosed herein without creative effort.

FIG. 1A is a pixel polarity of each pixel unit of an odd frame screen of a conventional pixel structure;

FIG. 1B is a pixel polarity of each pixel unit of an even frame screen of a conventional pixel structure;

FIG. 2A is a structural schematic diagram of a first preferred embodiment of a pixel structure of the present invention upon displaying an odd frame screen;

FIG. 2B is a structural schematic diagram of a first preferred embodiment of a pixel structure of the present invention upon displaying an even frame screen;

FIG. 3A is a structural schematic diagram of a second preferred embodiment of a pixel structure of the present invention upon displaying an odd frame screen; and

FIG. 3B is a structural schematic diagram of a second preferred embodiment of a pixel structure of the present invention upon displaying an even frame screen.

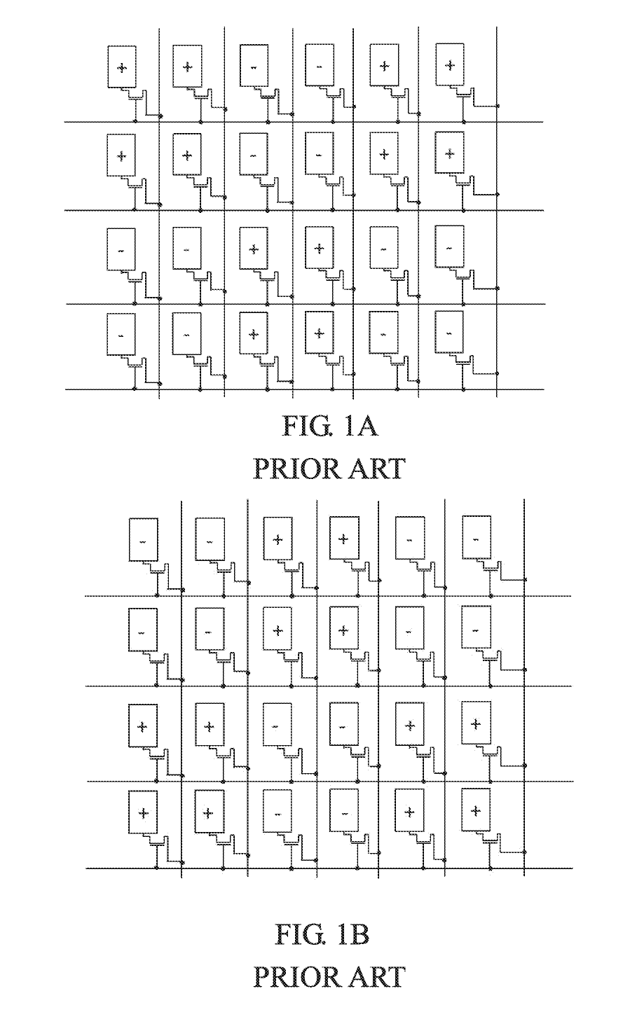

### DETAILED DESCRIPTION OF THE PREFERRED EMBODIMENTS

Please refer to figures in the drawings, wherein the same element number represents the same element. The following description is based on the illustrations of the specific embodiments of the present invention, but is not restricting of other embodiments of the present invention which are not revealed.

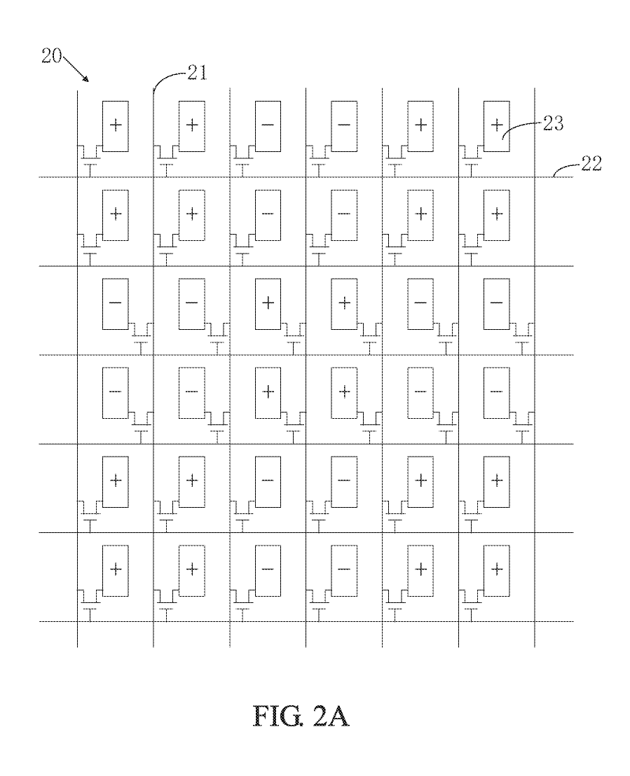

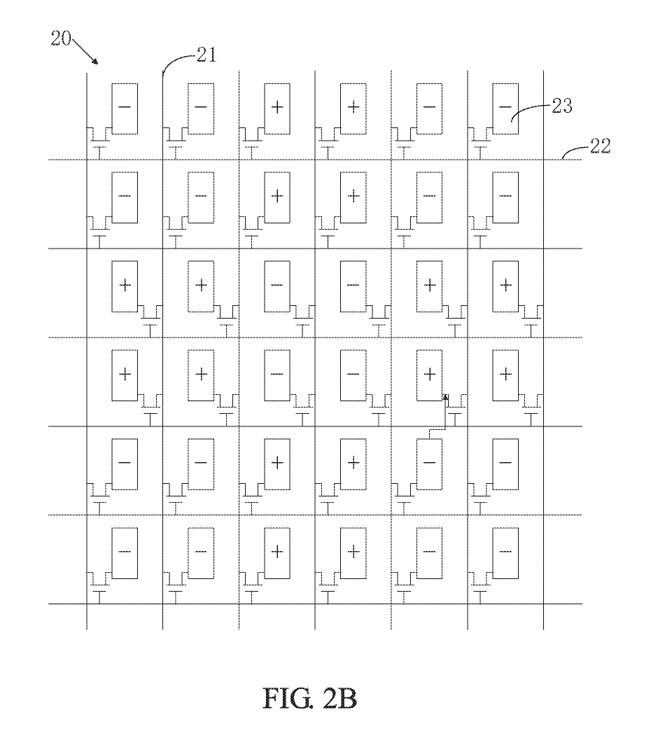

Please refer to FIG. 2A and FIG. 2B. FIG. 2A is a structural schematic diagram of a first preferred embodiment of a pixel structure of the present invention upon displaying an odd frame screen; and FIG. 2B is a structural schematic diagram of a first preferred embodiment of a pixel structure of the present invention upon displaying an even frame screen. A pixel structure 20 of the preferred embodiment comprises a plurality of data lines 21, a plurality of scan lines 22 and a plurality of pixel units 23 disposed between the data lines 21 and the scan lines 22, wherein connecting relationships among the pixel units 23, the data lines 21 and the scan lines 22 are shown as follows:

An Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)st data line.

A pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row.

A pixel polarity of an Mth pixel unit of a (4N+1)st column is identical to that of an Mth pixel unit of a (4N+2)nd column; a pixel polarity of the Mth pixel unit of the (4N+2)nd column is opposite that of an Mth pixel unit of a (4N+3)rd column; and a pixel polarity of the Mth pixel unit of the (4N+3)rd column is identical to that of an Mth pixel unit of a (4N+4)th column.

The pixel polarity of the Mth pixel unit of the (4N+1)th row is identical to that of an Mth pixel unit of a (4N+5)th row; and the pixel polarity of the Mth pixel unit of the (4N+1)th column is identical to that of an Mth pixel unit of a (4N+5)th column.

The pixel unit of an Ath row is connected to the Ath scan line.

Wherein N is a non-negative integer, M is a positive integer and A is a positive integer.

When the pixel structure of the present preferred embodiment is used to display, a two-line inversion is used for the polarity of the pixel unit in the pixel structure, i.e., an inversion of the pixel polarity is performed to pixel units every two rows, and an inversion of the pixel polarity is performed to pixel units every two columns. This can ensure a corresponding liquid crystal display panel with a better screen display quality.

As shown in FIG. 2A, when the pixel structure of the present preferred embodiment is used to display an odd frame screen, the pixel units 23 of a first row and first and second columns are positive polarities, the pixel units 23 of the first row and third and fourth columns are negative polarities, . . . , the pixel units 23 of the first row and (4N+1)st, (4N+2)nd columns are positive polarities, and the pixel units 23 of the first row and (4N+3)rd, (4N+4)th columns are negative polarities.

The pixel units 23 of a second row and first and second columns are positive polarities, the pixel units 23 of the second row and third and fourth columns are negative polarities, . . . , the pixel units 23 of the second row and (4N+1)st, (4N+2)nd columns are positive polarities, and the pixel units 23 of the second row and (4N+3)rd, (4N+4)th columns are negative polarities.

The pixel units 23 of a third row and first and second columns are negative polarities, the pixel units 23 of the third row and third and fourth columns are positive polarities, . . . , the pixel units 23 of the third row and (4N+1)st, (4N+2)nd columns are negative polarities, and the pixel units 23 of the third row and (4N+3)rd, (4N+4)th columns are positive polarities.

The pixel units 23 of a fourth row and first and second columns are negative polarities, the pixel units 23 of the fourth row and third and fourth columns are positive polarities, . . . , the pixel units 23 of the fourth row and (4N+1)st, (4N+2)nd columns are negative polarities, and the pixel units 23 of the fourth row and (4N+3)rd, (4N+4)th columns are positive polarities. . . .

The pixel units 23 of a (4N+1)th row and first and second columns are positive polarities, the pixel units 23 of the (4N+1)st row and third and fourth columns are negative polarities, . . . , the pixel units 23 of the (4N+1)st row and (4N+1)st, (4N+2)nd columns are positive polarities, and the pixel units 23 of the (4N+1)st row and (4N+3)rd, (4N+4)th columns are negative polarities.

The pixel units 23 of a (4N+2)nd row and first and second columns are positive polarities, the pixel units 23 of the (4N+2)nd row and third and fourth columns are negative polarities, . . . , the pixel units 23 of the (4N+2)nd row and (4N+1)st, (4N+2)nd columns are positive polarities, and the pixel units 23 of the (4N+2)nd row and (4N+3)rd, (4N+4)th columns are negative polarities.

The pixel units 23 of a (4N+3)rd row and first and second columns are negative polarities, the pixel units 23 of the (4N+3)rd row and third and fourth columns are positive polarities, . . . , the pixel units 23 of the (4N+3)rd row and (4N+1)st, (4N+2)nd columns are negative polarities, and the pixel units 23 of the (4N+3)rd row and (4N+3)rd, (4N+4)th columns are positive polarities.

The pixel units 23 of a (4N+4)th row and first and second columns are negative polarities, the pixel units 23 of the (4N+4)th row and third and fourth columns are positive polarities, . . . , the pixel units 23 of the (4N+4)th row and (4N+1)st, (4N+2)nd columns are negative polarities, and the pixel units 23 of the (4N+4)th row and (4N+3)rd, (4N+4)th columns are positive polarities.

When the pixel structure 20 of the preferred embodiment is used to scan a data signal of each of the pixel units 23 of an odd frame screen, using the first 6 rows of data lines 21 as an example, when the scan line 22 is used to scan the pixel units 23 of the first row, the data signals from a first column data line 21 to a sixth column data line 21 are respectively positive, positive, negative, negative, positive and positive. When the scan line 22 is used to scan the pixel units 23 of the second row, the data signals from the first column data line 21 to the sixth column data line 21 are respectively positive, positive, negative, negative, positive and positive. When the scan line 22 is used to scan the pixel units 23 of the third row, the data signals from the first column data line 21 to the sixth column data line 21 are respectively positive, negative, negative, positive, positive and negative. When the scan line 22 is used to scan the pixel units 23 of the fourth row, the data signals from the first column data line 21 to the sixth column data line 21 are respectively positive, negative, negative, positive, positive and negative . . . .

When the scan line 22 is used to scan the pixel units 23 of the (4N+1)st row, the data signals from the first column data line 21 to the sixth column data line 21 are respectively positive, positive, negative, negative, positive and positive. When the scan line 22 is used to scan the pixel units 23 of the (4N+2)nd row, the data signals from the first column data line 21 to the sixth column data line 21 are respectively positive, positive, negative, negative, positive and positive. When the scan line 22 is used to scan the pixel units 23 of the (4N+3)rd row, the data signals from the first column data line 21 to the sixth column data line 21 are respectively positive, negative, negative, positive, positive and negative. When the scan line 22 is used to scan the pixel units 23 of the (4N+4)th row, the data signals from the first column data line 21 to the sixth column data line 21 are respectively positive, negative, negative, positive, positive and negative.

That is, the polarity of the data signal of the data line 21 of the odd column in the same frame screen is not inverted, and the polarity of the data signal of the data line 21 of the even column in the same frame screen is to perform a two-line inversion, i.e., the polarities of the data signals are inverted every two rows.

As shown in FIG. 2B, when the pixel structure 20 of the preferred embodiment is used to display an even frame screen, the polarity of the pixel unit is opposite that of the pixel unit upon displaying the odd frame screen.

The first 6 rows of data lines 21 are used as an example, when the pixel structure 20 of the preferred embodiment is used to scan a data signal of each of the pixel units of an even frame screen. When the scan line 22 is used to scan the pixel units 23 of the first row, the data signals from a first column data line 21 to a sixth column data line 21 are respectively negative, negative, positive, positive, negative and negative. When the scan line 22 is used to scan the pixel units 23 of the second row, the data signals from the first column data line 21 to the sixth column data line 21 are respectively negative, negative, positive, positive, negative and negative. When the scan line 22 is used to scan the pixel units 23 of the third row, the data signals from the first column data line 21 to the sixth column data line 21 are respectively negative, positive, positive, negative, negative and positive. When the scan line 22 is used to scan the pixel units 23 of the fourth row, the data signals from the first column data line 21 to the sixth column data line 21 are respectively negative, positive, positive, negative, negative and positive . . . .

When the scan line 22 is used to scan the pixel units 23 of the (4N+1)st row, the data signals from the first column data line 21 to the sixth column data line 21 are respectively negative, negative, positive, positive, negative and negative. When the scan line 22 is used to scan the pixel units 23 of the (4N+2)nd row, the data signals from the first column data line 21 to the sixth column data line 21 are respectively negative, negative, positive, positive, negative and negative. When the scan line 22 is used to scan the pixel units 23 of the (4N+3)rd row, the data signals from the first column data line 21 to the sixth column data line 21 are respectively negative, positive, positive, negative, negative and positive. When the scan line 22 is used to scan the pixel units 23 of the (4N+4)th row, the data signals from the first column data line 21 to the sixth column data line 21 are respectively negative, positive, positive, negative, negative and positive.

Simultaneously, the polarity of the data signal of the data line 21 of the odd column in the same frame screen is not inverted, and the polarity of the data signal of the data line 21 of the even column in the same frame screen is to perform a two-line inversion.

Therefore, the pixel structure 20 of the present preferred embodiment can better decrease a polarity inversion frequency of the data signal in every frame screen.

The pixel structure 20 of the present preferred embodiment is merely limited to the connecting relationship among the pixel units 23, the data lines 21 and the scan lines 21 of a middle part of the liquid crystal display panel. As for the pixel units of an edge part of the liquid crystal display panel, specialized data lines 21 may be disposed to connect, based on satisfying a polarity feature of the above pixel units. There is a less effect on a fabricating cost of the liquid crystal display panel.

The pixel structure 20 of the present preferred embodiment can comprise red pixel units, green pixel units, and blue pixel units, and can also comprise red pixel units, green pixel units, blue pixel units, and white pixel units. Species of the specific pixel units in the pixel structure can be selected according to a user's requirement.

The pixel structure of the present preferred embodiment can decrease an inverting frequency of the polarity of the data signal in every screen, thereby decreasing the power consumption of the corresponding liquid crystal display panel and improving the display stability of the corresponding liquid crystal display panel.

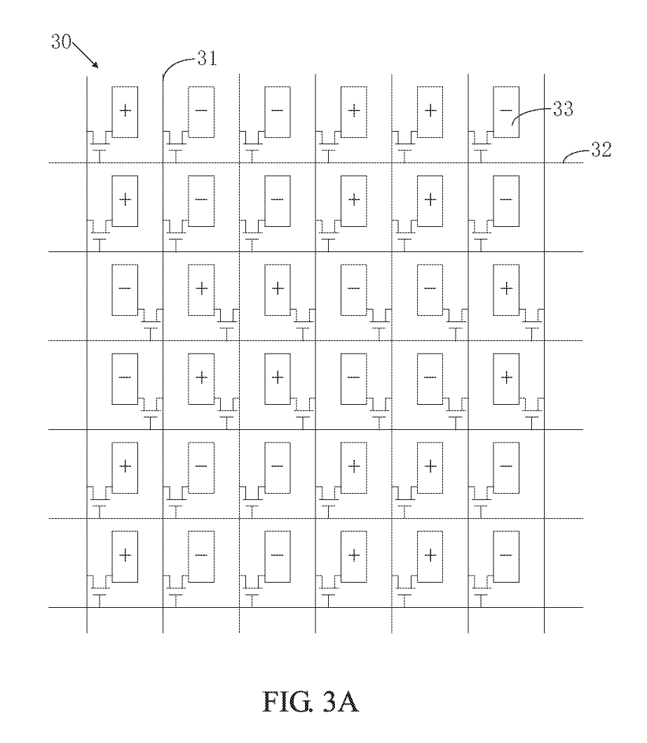

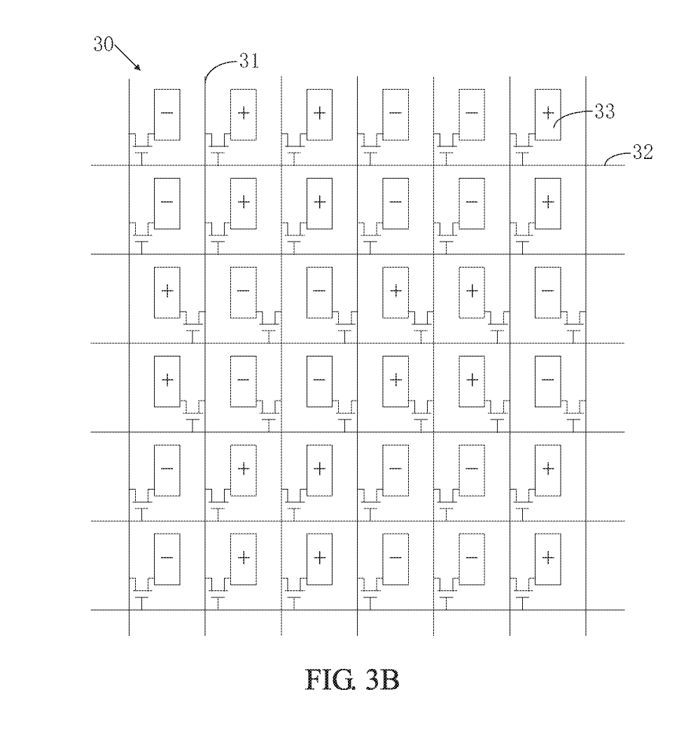

Please refer to FIG. 3A and FIG. 3B. FIG. 3A is a structural schematic diagram of a second preferred embodiment of a pixel structure of the present invention upon displaying an odd frame screen; and FIG. 3B is a structural schematic diagram of a second preferred embodiment of a pixel structure of the present invention upon displaying an even frame screen. A pixel structure 30 of the preferred embodiment comprises a plurality of data lines 31, a plurality of scan lines 32, and a plurality of pixel units 33 disposed between the data lines 31 and the scan lines 32, wherein connecting relationships among the pixel units 33, the data lines 31 and the scan lines 32 are shown as follows:

An Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)st data line.

A pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row.

A pixel polarity of an Mth pixel unit of a (4N+1)st column is opposite that of an Mth pixel unit of a (4N+2)nd column; a pixel polarity of the Mth pixel unit of the (4N+2)nd column is identical to that of an Mth pixel unit of a (4N+3)rd column; and a pixel polarity of the Mth pixel unit of the (4N+3)rd column is opposite that of an Mth pixel unit of a (4N+4)th column.

The pixel unit of an Ath row is connected to the Ath scan line.

Wherein N is a non-negative integer, M is a positive integer and A is a positive integer.

As shown in FIG. 3A, when the pixel structure of the present preferred embodiment is used to display an odd frame screen, the pixel units 33 of a first row and first and fourth columns are positive polarities, the pixel units 33 of the first row and second and third columns are negative polarities, . . . , the pixel units 33 of the first row and (4N+1)st, (4N+4)th columns are positive polarities, and the pixel units 33 of the first row and (4N+2)nd, (4N+3)rd columns are negative polarities.

The pixel units 33 of a second row and first and fourth columns are positive polarities, the pixel units 33 of the second row and second and third columns are negative polarities, . . . , the pixel units 33 of the second row and (4N+1)st, (4N+4)th columns are positive polarities, and the pixel units 33 of the second row and (4N+2)nd, (4N+3)rd columns are negative polarities.

The pixel units 33 of a third row and first and fourth columns are negative polarities, the pixel units 33 of the third row and second and third columns are positive polarities, . . . , the pixel units 33 of the third row and (4N+1)st, (4N+4)th columns are negative polarities, and the pixel units 33 of the third row and (4N+2)nd, (4N+3)rd columns are positive polarities.

The pixel units 33 of a fourth row and first and fourth columns are negative polarities, the pixel units 33 of the fourth row and second and third columns are positive polarities, . . . , the pixel units 33 of the fourth row and (4N+1)st, (4N+4)th columns are negative polarities, and the pixel units 33 of the fourth row and (4N+2)nd, (4N+3)rd columns are positive polarities. . . .

The pixel units 33 of a (4N+1)st row and first and fourth columns are positive polarities, the pixel units 33 of the (4N+1)st row and second and third columns are negative polarities, . . . , the pixel units 33 of the (4N+1)st row and (4N+1)st, (4N+4)th columns are positive polarities, and the pixel units 33 of the (4N+1)st row and (4N+2)nd, (4N+3)rd columns are negative polarities.

The pixel units 33 of a (4N+2)nd row and first and fourth columns are positive polarities, the pixel units 33 of the (4N+2)nd row and second and third columns are negative polarities, . . . , the pixel units 33 of the (4N+2)nd row and (4N+1)st, (4N+4)th columns are positive polarities, and the pixel units 33 of the (4N+2)nd row and (4N+2)nd, (4N+3)rd columns are negative polarities.

The pixel units 33 of a (4N+3)rd row and first and fourth columns are negative polarities, the pixel units 33 of the (4N+3)rd row and second and third columns are positive polarities, . . . , the pixel units 33 of the (4N+3)th row and (4N+1)st, (4N+4)th columns are negative polarities, and the pixel units 33 of the (4N+3)rd row and (4N+2)nd, (4N+3)rd columns are positive polarities.

The pixel units 33 of a (4N+4)th row and first and fourth columns are negative polarities, the pixel units 33 of the (4N+4)th row and second and third columns are positive polarities, . . . , the pixel units 33 of the (4N+4)th row and (4N+1)st, (4N+4)th columns are negative polarities, and the pixel units 33 of the (4N+4)th row and (4N+2)nd, (4N+3)rd columns are positive polarities.

The first 6 rows of data lines 31 are used as an example when the pixel structure 30 of the preferred embodiment is used to scan a data signal of each of the pixel units 33 of an odd frame screen. When the scan line 32 is used to scan the pixel units 33 of the first row, the data signals from a first column data line 31 to a sixth column data line 31 are respectively positive, negative, negative, positive, positive and negative. When the scan line 32 is used to scan the pixel units 33 of the second row, the data signals from the first column data line 31 to the sixth column data line 31 are respectively positive, negative, negative, positive, positive and negative. When the scan line 32 is used to scan the pixel units 33 of the third row, the data signals from the first column data line 31 to the sixth column data line 31 are respectively negative, negative, positive, positive, negative and negative. When the scan line 32 is used to scan the pixel units 33 of the fourth row, the data signals from the first column data line 31 to the sixth column data line 31 are respectively negative, negative, positive, positive, negative and negative . . . .

When the scan line 32 is used to scan the pixel units 33 of the (4N+1)st row, the data signals from the first column data line 31 to the sixth column data line 31 are respectively positive, negative, negative, positive, positive and negative. When the scan line 32 is used to scan the pixel units 33 of the (4N+2)nd row, the data signals from the first column data line 31 to the sixth column data line 31 are respectively positive, negative, negative, positive, positive and negative. When the scan line 32 is used to scan the pixel units 33 of the (4N+3)rd row, the data signals from the first column data line 31 to the sixth column data line 31 are respectively negative, negative, positive, positive, negative and negative. When the scan line 32 is used to scan the pixel units 33 of the (4N+4)th row, the data signals from the first column data line 31 to the sixth column data line 31 are respectively negative, negative, positive, positive, negative and negative.

That is, the polarity of the data signal of the data line 31 of the even column in the same frame screen is not inverted, and the polarity of the data signal of the data line 31 of the odd column in the same frame screen is to perform a two-line inversion, i.e., the polarities of the data signals are inverted every two rows.

As shown in FIG. 3B, when the pixel structure 30 of the preferred embodiment is used to display an even frame screen, the polarity of the pixel unit is opposite that of the pixel unit upon displaying the odd frame screen.

The first 6 rows of data lines 31 are used as an example when the pixel structure 30 of the preferred embodiment is used to scan a data signal of each of the pixel units of an even frame screen. When the scan line 32 is used to scan the pixel units 33 of the first row, the data signals from a first column data line 31 to a sixth column data line 31 are respectively negative, positive, positive, negative, negative and positive. When the scan line 32 is used to scan the pixel units 33 of the second row, the data signals from the first column data line 31 to the sixth column data line 31 are respectively negative, positive, positive, negative, negative and positive. When the scan line 32 is used to scan the pixel units 33 of the third row, the data signals from the first column data line 31 to the sixth column data line 31 are respectively positive, positive, negative, negative, positive and positive. When the scan line 32 is used to scan the pixel units 33 of the fourth row, the data signals from the first column data line 31 to the sixth column data line 31 are respectively positive, positive, negative, negative, positive and positive . . . .

When the scan line 32 is used to scan the pixel units 33 of the (4N+1)st row, the data signals from the first column data line 31 to the sixth column data line 31 are respectively negative, positive, positive, negative, negative and positive. When the scan line 32 is used to scan the pixel units 33 of the (4N+2)nd row, the data signals from the first column data line 31 to the sixth column data line 31 are respectively negative, positive, positive, negative, negative and positive. When the scan line 32 is used to scan the pixel units 33 of the (4N+3)rd row, the data signals from the first column data line 31 to the sixth column data line 31 are respectively positive, positive, negative, negative, positive and positive. When the scan line 32 is used to scan the pixel units 33 of the (4N+4)th row, the data signals from the first column data line 31 to the sixth column data line 31 are respectively positive, positive, negative, negative, positive and positive.

Simultaneously, the polarity of the data signal of the data line 31 of the even column in the same frame screen is not inverted, and the polarity of the data signal of the data line 31 of the odd column in the same frame screen is to perform a two-line inversion.

Therefore, the pixel structure 30 of the present preferred embodiment can simultaneously be better to decrease a polarity inversion frequency of the data signal in every frame screen.

The pixel structure 30 of the present preferred embodiment is merely limited to the connecting relationship among the pixel units 33, the data lines 31, and the scan lines 31 of a middle part of the liquid crystal display panel. As for the pixel units of an edge part of the liquid crystal display panel, specialized data lines 31 may be disposed to connect, based on satisfying a polarity feature of the above pixel units. There is a less effect on a fabricating cost of the liquid crystal display panel.

The pixel structure 30 of the present preferred embodiment can comprise red pixel units, green pixel units, and blue pixel units, and also can comprise red pixel units, green pixel units, blue pixel units, and white pixel units. Species of the specific pixel units in the pixel structure can be selected according to a user's requirement.

The pixel structure of the present preferred embodiment can simultaneously decrease an inverting frequency of the polarity of the data signal in every screen, thereby decreasing the power consumption of the corresponding liquid crystal display panel and improving the display stability of the corresponding liquid crystal display panel.

The present invention further provides a liquid crystal display panel. The liquid crystal display panel comprises the above pixel structure and a corresponding panel driving current. The pixel structure comprises a plurality of data lines, a plurality of scan lines, and a plurality of pixel units disposed between the data lines and the scan lines.

A specific working principle of the liquid crystal display panel of the present invention is identical to or similar to that described in the preferred embodiment of the above pixel structure. For details, please refer to the related descriptions in the preferred embodiment of the above pixel structure.

The pixel structure and the corresponding liquid crystal display panel of the present invention can decrease an inverting frequency of the polarity of the data signal in every screen, thereby decreasing the power consumption of the corresponding liquid crystal display panel and improving the display stability of the corresponding liquid crystal display panel. The technical problems of the greater power consumption and the relatively poor display stability of the conventional pixel structure and the corresponding liquid crystal display panel are solved.

As described above, although the present invention has been described in preferred embodiments, they are not intended to limit the invention. One of ordinary skill in the art, without departing from the spirit and scope of the invention within, can make various modifications and variations, so the range of the scope of the invention is defined by the claims.

What is claimed is:

1. A pixel structure, comprising a plurality of data lines, a plurality of scan lines and a plurality of pixel units disposed between the data lines and the scan lines,
wherein an Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)st data line;
wherein a pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row;
wherein a pixel polarity of an Mth pixel unit of a (4N+1)st column is identical to that of an Mth pixel unit of a (4N+2)nd column; a pixel polarity of the Mth pixel unit of the (4N+2)nd column is opposite that of an Mth pixel unit of a (4N+3)rd column; and a pixel polarity of the Mth pixel unit of the (4N+3)rd column is identical to that of an Mth pixel unit of a (4N+4)th column;
wherein N is a non-negative integer, and M is a positive integer.

2. The pixel structure according to claim 1, wherein an inversion is performed to a polarity of a data signal of an odd column data line of a neighboring frame; and a two-line inversion is performed to a polarity of a data signal of an even column data line in the same frame screen.

3. The pixel structure according to claim 1, wherein the pixel unit of an Ath row is connected to the Ath scan line, wherein A is a positive integer.

4. The pixel structure according to claim 1, wherein the pixel structure comprises red pixel units, green pixel units, and blue pixel units.

5. The pixel structure according to claim 1, wherein the pixel structure comprises red pixel units, green pixel units, blue pixel units, and white pixel units.

6. The pixel structure according to claim 1, wherein the pixel polarity of the Mth pixel unit of the (4N+1)st row is identical to that of an Mth pixel unit of a (4N+5)th row.

7. The pixel structure according to claim 1, wherein the pixel polarity of the Mth pixel unit of the (4N+1)st column is identical to that of an Mth pixel unit of a (4N+5)th column.

8. A pixel structure, comprising a plurality of data lines, a plurality of scan lines and a plurality of pixel units disposed between the data lines and the scan lines,
wherein an Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)th data line; and an Mth pixel unit of a (4N+4)th row is connected to the (M+1)th data line;
wherein a pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row;
wherein a pixel polarity of an Mth pixel unit of a (4N+1)st column is opposite that of an Mth pixel unit of a (4N+2)nd column; a pixel polarity of the Mth pixel unit of the (4N+2)nd column is identical to that of an Mth pixel unit of a (4N+3)rd column; and a pixel polarity of the Mth pixel unit of the (4N+3)rd column is opposite that of an Mth pixel unit of a (4N+4)th column;
wherein N is a non-negative integer, and M is a positive integer.

9. The pixel structure according to claim 8, wherein an inversion is performed to a polarity of a data signal of an even column data line of a neighboring frame; and a two-line inversion is performed to a polarity of a data signal of an odd column data line in the same frame screen.

10. The pixel structure according to claim 8, the pixel unit of an Ath row is connected to the Ath scan line, wherein A is a positive integer.

11. The pixel structure according to claim 8, wherein the pixel structure comprises red pixel units, green pixel units, and blue pixel units.

12. The pixel structure according to claim 8, wherein the pixel structure comprises red pixel units, green pixel units, blue pixel units, and white pixel units.

13. The pixel structure according to claim 8, wherein the pixel polarity of the Mth pixel unit of the (4N+1)st row is identical to that of an Mth pixel unit of a (4N+5)th row.

14. The pixel structure according to claim 8, wherein the pixel polarity of the Mth pixel unit of the (4N+1)st column is identical to that of an Mth pixel unit of a (4N+5)th column.

15. A liquid crystal display panel, comprising a pixel structure and a driving current configured to drive the pixel structure, wherein the pixel structure comprises a plurality of data lines, a plurality of scan lines and a plurality of pixel units disposed between the data lines and the scan lines,
wherein an Mth pixel unit of a (4N+1)st row is connected to an Mth data line; an Mth pixel unit of a (4N+2)nd row is connected to the Mth data line; an Mth pixel unit of a (4N+3)rd row is connected to an (M+1)st data line; and an Mth pixel unit of a (4N+4)th row is connected to the (M+1)th data line;
wherein a pixel polarity of the Mth pixel unit of the (4N+1)st row is identical to that of the Mth pixel unit of the (4N+2)nd row; a pixel polarity of the Mth pixel unit of the (4N+2)nd row is opposite that of the Mth pixel unit of the (4N+3)rd row; and a pixel polarity of the Mth pixel unit of the (4N+3)rd row is identical to that of the Mth pixel unit of the (4N+4)th row;
wherein a pixel polarity of an Mth pixel unit of a (4N+1)st column is identical to that of an Mth pixel unit of a (4N+2)nd column; a pixel polarity of the Mth pixel unit of the (4N+2)nd column is opposite that of an Mth pixel unit of a (4N+3)rd column; and a pixel polarity of the Mth pixel unit of the (4N+3)rd column is identical to that of an Mth pixel unit of a (4N+4)th column;
wherein N is a non-negative integer, and M is a positive integer.

16. The liquid crystal display panel according to claim 15, wherein an inversion is performed to a polarity of a data signal of an odd column data line of a neighboring frame; and a two-line inversion is performed to a polarity of a data signal of an even column data line in the same frame screen.

17. The liquid crystal display panel according to claim 15, wherein the pixel unit of an Ath row is connected to the Ath scan line, wherein A is a positive integer.

18. The liquid crystal display panel according to claim 15, wherein the pixel structure comprises red pixel units, green pixel units, and blue pixel units.

19. The liquid crystal display panel according to claim 15, wherein the pixel structure comprises red pixel units, green pixel units, blue pixel units, and white pixel units.
